(19) United States
(12) Patent Application Publication
(10) Pub. No.: US 2011/0104824 A1
(43) Pub. Date: May 5, 2011

(54) MULTI-CHANNEL SAW SENSOR CHIP

(75) Inventors: Markus Perpeet, Wuppertal (DE); Ulrich Schlecht, Bonn (DE)

(73) Assignee: BIOSENSOR GMBH, BONN (DE)

(21) Appl. No.: 13/001,450

(22) PCT Filed: Jun. 8, 2009
(86) PCT No.: PCT/EP2009/057058

§ 371 Date: Dec. 27, 2010

(30) Foreign Application Priority Data
Jun. 25, 2008 (DE) 10 2008 029 843.3

(51) Int. Cl. G01N 30/00

(52) U.S. Cl. 436/518; 422/69

(57) ABSTRACT

A sensor chip for specific analysis of analytes in a liquid includes a plurality of sensor elements based on the SAW principle and applied as layer structures onto a surface of a substrate. A surface of each sensor element is coated with a sensitive substrate or coating having receptors specifically binding one analyte. During operation, the surface of the sensor chip rests against and seals a half-open covering part, with the covering part and the sensor chip forming a flow cell to be rinsed by the liquid. Conductor structures contact the sensor elements from the flow cell. More than six sensor elements are present which can each be triggered and read out separately via control and measuring electronics. At least two and in particular all sensor elements, are each coated with a differently sensitive substrate and the sensitive substrate is applied to the surface before attachment of the cover part.

The invention relates to a sensor chip for the specific analysis of analytes in a liquid, comprising a plurality of sensor elements based on the SAW principle that are applied as layer structures to the surface of a substrate, the surface of the sensor elements being covered in each case with a sensitive substrate (coating) comprising receptors binding specifically to analytes, the surface of the sensor chip lying tightly against a half-open cover part during operation, the cover part and the sensor chip forming a flow cell to be rinsed thoroughly with the liquid, conductor structures for contacting the sensor elements being led through the flow cell. The invention also relates to a method for controlling and reading a sensor chip of this type and a manageable unit with a sensor chip of this type.

Nowadays, relatively compact systems are known in the form of laboratory devices with which biomolecules can be detected conveniently at low concentrations and without the use of markers. In particular, these build on sensor chips that utilise the physical principle of the surface acoustic wave, or SAW for short. SAW sensors of this type can detect minimal changes in mass over the surface of the sensor, which is coated with receptor molecules sensitive to the analytes to be detected. However, considerable technical experience as well as (bio)chemical and physical knowledge are required for operation of these systems and, in particular, analysis of the analyte molecules dissolved in liquid with the aid of receptor molecules. The known systems are not suitable for rapid use and are also particularly unsuitable for field use and for operation by staff not experienced in the use of these systems.

A sensor of this type for integration into a laboratory device is, for example, sold by the applicant under the name ‘K5’. This sensor chip comprises five separately controllable sensor elements arranged in parallel so it is possible to carry out the same measurement on the liquid charged with analyte a number of times in one go in order to minimise errors of measurement and thus achieve a reliable measurement result. Contacting the sensor chip in the device is relatively complex since four connections are provided per sensor element and there are also connections to earth for the screening layer. An increase in the number of individual sensors is not expedient owing to the minimal benefit obtained by the improved reliability of the measurement.

In addition, with known sensor chips the coating is applied in the incorporated ‘operating state’ in which the sensor chip is covered by the cover part and forms a flow cell together with the cover part. Receptors, for example anti-thrombin aptamers, are immobilised on the surface of the individual sensors, within a first rinsing process, using carbodiimide chemistry before any measurements are taken. The chip is then ready for the actual measurement of the liquid charged with analyte. The operational effort required for the measurement is also relatively high as a result of this preparatory step so the measurements are still carried out predominantly in laboratories. Miniaturisation in view of rapid measurements with manageable units is not possible.

The object of the present invention is to provide a sensor chip that can be operated easily and reliably, even with an increased number of individual sensors, enables simultaneous measurements of different analytes in the liquid and, above all, can also be used conveniently in a mobile system. The invention also relates to a method for reading a sensor chip of this type and the provision of a manageable unit with a sensor chip of this type.

These objects are achieved by a sensor chip having the features of claim 1, the method according to claim 11 and the manageable unit according to claim 12. Advantageous embodiments are disclosed in the respective sub-claims.

One of the main fundamental ideas of the invention is to equip the sensor chip with a plurality of, namely more than six, simultaneously operating sensor elements that each enable SAW measurements, each individual sensor element corresponding specifically to a special substance. The respective sensor element remains ‘blind’ to other substances. In accordance with the invention at least two of the sensor elements, but particularly all the sensor elements are each coated with a substrate that is sensitive to a further analyte. This sensitivity is achieved by special receptor molecules on the sensitive regions of the sensor elements. In accordance with the invention these molecules are also applied to the surface as a sensitive substrate before the cover part is applied. A sensor chip of this type is thus immediately ready for operation and can be sold on an industrial scale as an easily manageable component for manageable systems. The more than six sensor elements are each separately excitable and readable via an electronic control and measurement device.

A plurality of various contents of a liquid sample can be detected and their concentration evaluated using a sensor chip of this type within the scope of a single test procedure. Sophisticated testing of a liquid sample for a single substance or a plurality of substances from a range of various potentially possible substances is also enabled. As the test result the SAW-based sensor chip delivers a signal that can be allocated to the substances and evaluated electronically.

Sensor chips of the type according to the invention can be integrated into special modules (cartridges) and act as a consumable material in association with the manageable devices. In particular these systems can identify and quantify illegal drugs, explosives, poisonous substances and/or hazardous substances by electronic-biochemical means.

With regard to simple handling and reliable operation within the manageable units in particular, it is particularly advantageous for the sensor elements to comprise rectangular and, in particular, identical sensor strips that are arranged in parallel on a corresponding carrier and are insulated relative to one another. It has also proven to be advantageous to provide the sensor chip with more than ten, in particular twelve sensor elements in the form of sensor strips arranged in parallel.

The carrier can be formed by a monocrystalline piezoelectric. For contacting, the sensor strips each comprise two conductor structures on each end face. The sensor strips advantageously consist of a metal layer, particularly a gold or aluminium layer less than 500 nm thick. This is applied in a structured manner to the carrier and is covered by a common guide layer conducting the mechanical waves, for example a layer made of SiO₂. The guide layer has a thickness of a few micrometres, the cover part being sealed relative to this guide layer. It is also advantageous to cover the sensor strips, via the guide layer, in each case with a screening strip that shields against interfering signals and is in turn formed, in particular, by a gold layer approximately 100 nm thick. These screening strips carry the biologically sensitive substrate applied before use.

In order to control the sensor chip comprising a large number of SAW-based individual sensors, each of which typically has four to six electrical contacts, correspondingly robust possibilities for contacting are necessary. Contacting should be reversible and possible with low technical effort. The sensor chip achieves robust contacts, in particular over the contact surface of the individual contacts (contact pads). However, in conjunction with the required number of contact pads the size thereof constitutes a decisively limiting factor with regard to miniaturisation. A reduction in the size of the sensor chips is always desirable with regard to cost since costs increase proportionally with chip size.

A further essential feature of the invention is therefore the specific type of contacting of the individual sensor elements, in particular the sensor strips. Since these are to be separately excitable via the electronic control and measurement device, a large number of contacts is necessary which, as illustrated, means a particularly complex design of the sensor chip and complex contacting. The contacting process in accordance with the invention assumes that the number of contacts is reduced by consolidation of various contact pads. In accordance with the invention individual contact pads are used jointly by a plurality of individual sensors. This idea contributes to a significant reduction in the size of the sensor chip. The sophisticated reading of the signals requires a special ‘intelligent’ controller, which also constitutes an essential inventive feature.

In order to control two parallel sensor elements via a common contact pad it is advantageous for (N−1)+2 contact means to be allocated to the number of N sensor elements on each end face. This number is calculated from the fact that N sensor elements are arranged beside one another in series, of which the N−1 ones that each have two neighbours are to be contacted via a common contact pad. The 2 outer sensor elements each require an additional contact pad that is allocated solely to the respective outer sensor element. The N−1 contact means thus each contact two adjacent individual sensors, the remaining two contact means each contacting the two individual sensors arranged at the edge. The individual sensors can be controlled and read sequentially and separately via a contact pad arrangement of this type.

It is advantageous for the N−1 contact means to act alternately as a phase connection and then as a connection to earth, each of the phase connections and each of the connections to earth contacting two adjacent individual sensors. During the control and reading processes the phase connections arranged on one side of the sensor chip feed excitation signals and the phase connections arranged on the opposite side of the sensor chip tap the measurement signals resulting therefrom.

The individual sensor can thus indicate the presence of an individual substance to which it reacts specifically. An indication regarding the amount of the substance present, i.e. regarding concentration, can also be provided by the intensity of the measurement signal. As a whole, the sensor chip thus forms a detector with its multiple individual sensor elements, said detector being able to simultaneously identify a large number of various substances during a single test procedure and also quantify the concentration of these substances. Sensor chips of the type described can be integrated into special cartridges. In particular, they can be designed as consumption material and used in devices that can identify and quantify illegal drugs, explosives and other poisonous and hazardous substances by electronic-biochemical means. With regard to the consumption material it is advantageous for cartridges of this type to be produced cost-effectively. As the most expensive component in a cartridge of this type, a cost-reduced sensor chip could make a considerable contribution to a reduction in the overall cost.

The cartridge thus also constitutes a further essential feature of the invention and forms a suitable manageable unit together with the sensor chip according to the invention. In conjunction with the sensor chip this unit advantageously forms a flow cell for guiding a liquid, the liquid charged with analyte being guided in the flow cell over the sensitive sensor surfaces. In accordance with the invention the flow cell comprises a cover part that lies tightly against the surface of the sensor chip and surrounds the sensitive sensor surfaces. For sealing, the edge of the cover part lies tightly against the sensor surface via a seal, means for bracing the cover part against the seal being provided and the sensor chip comprising strip conductors for contacting the sensor surface that are led through the flow cell.

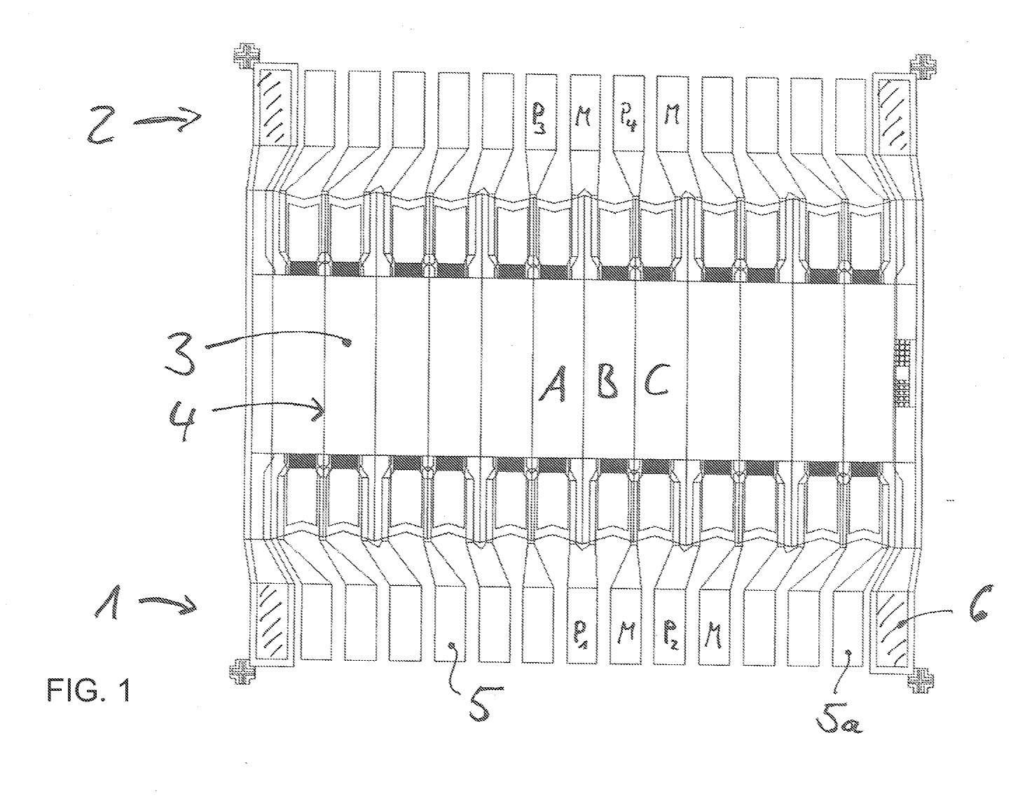

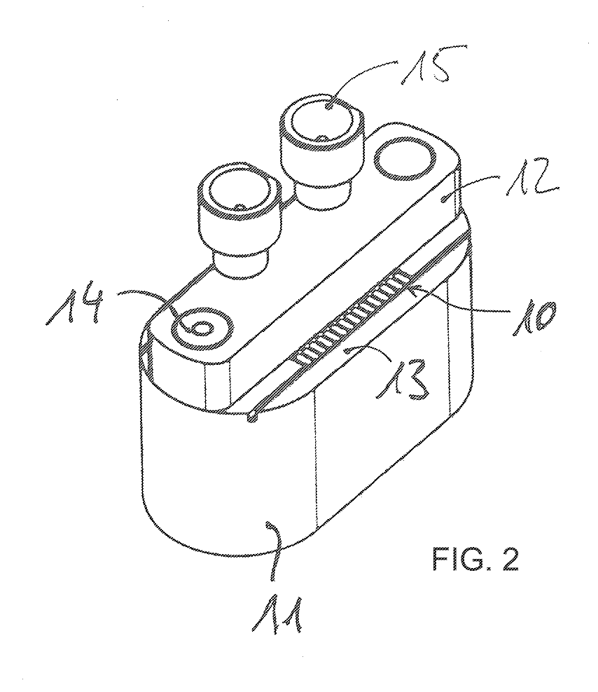

The invention will be described in greater detail hereinafter with reference to FIGS. 1 and 2, in which:

FIG. 1 is a plan view of a 12-channel sensor chip, and

FIG. 2 shows a cartridge.

FIG. 1 shows a 12-channel sensor chip that has a first side 1 for the signal input and a second side 2 for the signal output.

The sensor chip comprises 12 sensor elements that are configured as rectangular, identical sensor strips 3. The sensor strips 3 are arranged in parallel on a carrier (not shown) formed of a monocrystalline piezoelectric via a joint 4 and are insulated relative to one another. Conductor structures for contacting are provided on the end faces of the sensor strips 3, two conductor structures being allocated to each sensor strip 3 on each end face.

In this instance a number of (N−1)+2=13 contact pads 5 is allocated to the number of N=12 sensor strips 3, in each case on each end face. In addition, four connections to earth 6 are provided for the entire sensor chip at the corners, are illustrated by hatching and contact the screening layer or screening strips. Selectively-binding haptenes are applied to the screening strips, a rigid haptene bond to the surface of the screening strip being provided following drying of the respective haptene.

Each of the 13 contact pads 5 contacts two adjacent sensor strips 3 and bridges the respective joints 4. Two outer contact means 5a each contact the two sensor strips 3 arranged at the edge. The number of contacts on a sensor chip can be considerably reduced by combining, in each case, two earth contacts or two phase contacts of two adjacent sensor strips 3 in a common contact pad. In addition, the earth of all senor elements is combined centrally and contacted with only a few electrical connections, namely the connections to earth 6.

The contact pads 5 alternately form a phase connection P and a connection to earth M. The phase connections P on the first side of the sensor chip are provided for feeding the high-frequency excitation signals and the phase connections P arranged offset on the other side of the sensor chip are provided for tapping the measurement signals resulting therefrom. In this instance the phase connection P1 contacts the sensor strips A and B.

If the contact pads are combined in the manner according to the invention, two sensor elements will always be excited simultaneously when a HF signal is fed into a phase pad on the input side. The same applies to the output, where two sensor elements will always be read simultaneously. So as to ensure unambiguity, it is necessary for the signal feed and the corresponding signal read-out to be staggered in order to clearly detect the signal of only one individual sensor element.

The method steps are illustrated with reference to the sensor strips A, B and C. The two adjacent sensor strips A and B are excited simultaneously via the common phase connection P1. At the output both P3 and P4 may be used for reading. The measurement signal generated by the first sensor element A is read via the opposing phase connection P3, which is allocated to the first sensor element A and the adjacent sensor element on the side opposite the second sensor element B. The measurement signal generated by the second sensor element B can be read in a time-delayed manner via the opposite phase connection P4, which is allocated to the second sensor element B and the adjacent sensor element C on the side opposite the first sensor element. Electronic or software-based control that carries out the staggered excitation and read-out processes is required in order to achieve the described concept for sophisticated signal detection.

FIG. 2 shows a complete manageable unit (cartridge) as it can be used in a particularly mobile system. The base of the system forms the SAW-based multi-channel sensor chip, of which the surface is provided with biochemical receptor molecules. In this instance merely the contact strip 10 of the sensor chip can be seen. A mobile system (not illustrated) of this type advantageously comprises a feed module for simple feeding of the analyte. In particular, collecting wipes that particularly collect samples of bodily fluids such as sweat offer rapid and uncomplicated analyses. In addition, a fluidics module is to be provided where the analyte is introduced into a liquid acting as a transport means. The fluidics module is provided for guiding the liquid charged with analyte via corresponding channels. A control and analysis unit is also provided to take measurements automatically. In particular, this unit comprises a microcomputer that controls the sensor chip via signal frequencies and evaluates the measurement results. The measurement results are supplied to the user via output means, such as a display and/or a printer.

The two housing parts 11 and 12 of the cartridge can be seen and abut one another via support faces, the support face 13 of the first housing part 11 being larger and acting as a counter support for the strip conductors 10 projecting beneath the seal. The strip conductors form a comb-like conductor structure that lies on the contact face 13 of the housing part 11 and is freely accessible for electrical contact. This structure can cooperate with counter contacts provided correspondingly in the mobile system. On the whole, the geometry of the housing parts is dimensioned in such a way that the housing can be inserted into a corresponding socket with a positive fit. In the present case, the two housing parts 11 and 12 are connected via pin-like snap-in closures 14.

The flow cell formed by the sensor chip and the cover part (not shown) is supplied with the liquid to be examined via connections 15.

1-12. (canceled)

13. A sensor chip for the specific analysis of analytes in a liquid, the sensor chip comprising:
a sensor chip surface;
a substrate having a surface;
more than six sensor elements based on the SAW principle, each of said sensor elements configured to be separately excitable and readable via an electronic control and measurement device, said sensor elements being applied as layer structures to said surface of said substrate, and said sensor elements having a surface;
sensitive coatings having receptors binding specifically to analytes, said sensitive coatings including different sensitive coatings each covering said surface of a respective one of at least two of said sensor elements; and
conductor structures for contacting said sensor elements;
said sensor chip surface configured to lie tightly against a half-open cover part during operation after applying said sensitive coatings, with the cover part and the sensor chip forming a flow cell to be rinsed thoroughly with the liquid and said conductor structures for contacting said sensor elements being led through the flow cell.

14. The sensor chip according to claim 13, wherein all of said sensor elements are each coated with a different respective sensitive coating.

15. The sensor chip according to claim 13, wherein said sensor elements are rectangular sensor strips disposed in parallel on a carrier, insulated relative to one another and having end faces, said conductor structures contacting said end faces of said sensor strips and each two of said conductor structures being allocated to a respective one of said sensor strips on each end face.

16. The sensor chip according to claim 15, wherein said sensor strips are identical.

17. The sensor chip according to claim 15, wherein said carrier is a monocrystalline piezoelectric.

18. The sensor chip according to claim 15, wherein said sensor strips are formed by a metal layer being less than 500 nm thick and applied in a structured manner to the carrier, a common guide layer being a few micrometers thick is applied over all of said sensor strips, and the cover part is sealed relative to the guide layer.

19. The sensor chip according to claim 18, wherein said metal layer is made of gold or aluminum.

20. The sensor chip according to claim 18, wherein said common guide layer is made of SiO₂.

21. The sensor chip according to claim 18, which further comprises screening strips each covering a respective one of said sensor strips via the guide layer, said screening strips carrying the biologically sensitive substrate.

22. The sensor chip according to claim 18, wherein said screening strips are formed by a gold layer being approximately 100 nm thick.

23. The sensor chip according to claim 13, wherein said sensor elements are more than ten sensor elements provided with sensor strips disposed in parallel.

24. The sensor chip according to claim 13, wherein said sensor elements are twelve sensor elements provided with sensor strips disposed in parallel.

25. The sensor chip according to claim 13, wherein said sensor elements are a number N of sensor elements, and a number (N−1)+2 of contact means are allocated to said number N of sensor elements, on each respective end face.

26. The sensor chip according to claim 25, wherein each of said N−1 contact means contacts two adjacent individual sensors, and a remaining two contact means each contact two individual sensors disposed at an edge.

27. The sensor chip according to claim 26, wherein the sensor chip has sides, said N−1 contact means alternately form a phase connection and a connection to ground, each of said phase connections and each of said connections to ground contact two adjacent individual sensors, said phase connections disposed on one of said sides of the sensor chip feed excitation signals and said phase connections disposed on another of said sides of the sensor chip tap measurement signals resulting therefrom.

28. The sensor chip according to claim 21, which further comprises at least one contact means disposed on each end face and connected to said screening strips as a connection to ground.

29. The sensor chip according to claim 21, wherein said screening strips are configured to receive selectively-binding haptenes applied thereto and to provide a rigid haptene bond to a surface of said screening strips following drying of a respective haptene.

30. A method for controlling and reading a sensor chip, the method comprising the following steps:
providing a sensor chip according to claim 27;
exciting first and second adjacent sensor elements via a common phase connection;
reading the measurement signal generated by the first sensor element at an opposing phase connection being allocated to the first sensor element and an adjacent sensor element on a side opposite to the second sensor element; and
reading the measurement signal generated by the second sensor element in a time-delayed manner via the opposite phase connection being allocated to the second sensor element and the adjacent sensor element on the side opposite to the first sensor element.

31. A manageable unit, comprising:
a sensor chip according to claim 13 having strip conductors for contacting said sensor chip surface sensitive to analytes; and
a flow cell for guiding a fluid via said sensor chip surface, said flow cell having a cover part placed on said sensitive sensor chip surface, said cover part having an edge lying tightly against said sensor chip surface via a seal, said cover part being braced against said seal and said strip conductors being led through said flow cell.
